(19) United States
(12) Patent Application Publication
(10) Pub. No.: US 2026/0142302 A1
(43) Pub. Date: May 21, 2026

(54) BATTERY SYSTEM WITH NUT PROVIDING DUAL-SEALING

(71) Applicant: SAMSUNG SDI CO., LTD., Yongin-si (KR)

(72) Inventor: Manuel BAUER, Tillmitsch (AT)

(21) Appl. No.: 19/323,562

(22) Filed: Sep. 9, 2025

(30) Foreign Application Priority Data
Nov. 15, 2024 (EP) 24213372.6

(51) Int. Cl. H01M 50/262; B60K 1/04; B60L 50/64; H01M 50/204; H01M 50/249; H01M 50/271

(52) U.S. Cl. CPC H01M 50/262; B60K 1/04; B60L 50/64; H01M 50/204; H01M 50/249; H01M 50/271; H01M 2220/20

(57) ABSTRACT

A battery system includes: a battery housing including a frame and a cover plate on the frame to define an accommodation chamber; a plurality of battery cells accommodated in the accommodation chamber; and a nut. A tunnel configured to receive a fastener extends through the frame across the accommodation chamber. The frame includes a sleeve extending through an opening in the cover plate to an outer side of the cover plate. The nut is screwed onto an external thread of the sleeve to abut the outer side of the cover plate. The nut further includes a thread seal at its internal thread sealing the nut to the sleeve and an axial seal at the axial end face of the nut extending around the sleeve and sealing the nut to the outer side of the cover plate.

### CROSS-REFERENCE TO RELATED APPLICATION

The present application claims priority to and the benefit of European Patent Application No. 24213372.6, filed on Nov. 15, 2024, in the European Patent Office, the entire disclosure of which is incorporated herein by reference.

### BACKGROUND

### 1. Field

Aspects of embodiments of the present disclosure relate to a battery system with a nut providing dual-sealing.

### 2. Description of the Related Art

Recently, vehicles for transportation of goods and peoples have been developed that use electric power as a source for motion. Such an electric vehicle is an automobile that is propelled, permanently or temporarily, by an electric motor by using energy stored in rechargeable (or secondary) batteries. An electric vehicle may be powered solely by batteries (so-called Battery Electric Vehicles BEV) or may include a combination of an electric motor and, for example, a conventional combustion engine (so-called Plugin Hybrid Electric Vehicles PHEV). BEVs and PHEVs use high-capacity rechargeable batteries, which are designed to provide power for propulsion for sustained periods of time.

Generally, a rechargeable (or secondary) battery cell includes an electrode assembly including a positive electrode, a negative electrode, and a separator interposed between the electrodes. A solid or liquid electrolyte allows for the movement of ions during charging and discharging of the battery cell. The electrode assembly is located in (or is accommodated in) a casing and electrode terminals, which are positioned on the outside of the casing, establish an electrically conductive connection to the electrodes. The shape of the casing may be, for example, cylindrical or rectangular.

A battery module is formed of a plurality of battery cells connected together in series or in parallel. That is, the battery module is formed by interconnecting the electrode terminals of the plurality of battery cells together, with the number and connection configuration thereof depending on a desired amount of power, to provide a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or individual battery cells. The battery modules or, respectively, the battery cells, may be connected in a series, parallel, or series/parallel configuration to deliver the desired voltage, capacity, and/or power density. Components of a battery pack include the individual battery modules and interconnects, which provide electrical conductivity between the battery modules.

The mechanical integration of a battery pack is achieved by suitable mechanical connections between the individual components, for example, of the battery modules and between them and a supporting structure of the vehicle. These connections should remain functional and safe throughout the average service life of the battery system. Further, installation space and interchangeability should be considered, especially in mobile applications.

Mechanical integration of battery modules may be achieved by providing a carrier framework and by positioning the battery modules thereon. Fixing of the battery cells or battery modules may be achieved by fitted depressions in the framework or by mechanical interconnectors, such as bolts or screws. In some cases, the battery modules are confined by fastening side plates to lateral sides of the carrier framework. Further, cover plates may be fixed atop and below the battery modules.

The carrier framework of the battery pack is mounted to a carrying structure of the vehicle. When the battery pack is to be fixed at the bottom of the vehicle, the mechanical connection may be established from the bottom side by, for example, bolts passing through the carrier framework of the battery pack. The framework is usually made of aluminum or an aluminum alloy to reduce the total weight of the construction.

Conventional battery systems, despite any modular structure, usually include a battery housing that acts as enclosure to seal the battery system against the environment and to provide structural protection to the battery system's components. Housed battery systems are usually mounted as a whole into their application environment, such as an electric vehicle. Thus, the replacement of defective or damaged system parts, such as a defective battery submodule, requires dismounting the entire battery system and removal of its housing first. Even defects of small and/or cheap system parts might then lead to dismounting and replacement of the entire battery system and its separate repair. Because high-capacity battery systems are expensive, large, and heavy, this procedure is burdensome and the storage, such as in the mechanic's workshop, of the bulky battery systems is difficult.

### SUMMARY

Large battery systems face structural problems due to their length and width. A particular problem in the development of such battery systems is ensuring sufficient stability in the battery pack. Therefore, additional fastening elements, such as screw mounts in the middle of the battery pack and extending through the battery pack, may need to be provided. Such additional fastening elements, however, introduce places where water or other contaminants may enter the battery pack from the outside and cause safety issues. In other words, there might be a tightness or sealing problem.

According to embodiments of the present disclosure, a battery system is provided that exhibits sufficient stability while protecting the battery cells inside the battery system from water or other contaminants.

The present disclosure is defined by the appended claims and their equivalents. The description that follows is subject to this limitation. Any disclosure lying outside the scope of said claims and their equivalents is intended for illustrative as well as comparative purposes.

According to an embodiment of the present disclosure, a battery system includes a battery housing including a frame and a cover plate on or below the frame to form an accommodation chamber; a plurality of battery cells accommodated in the accommodation chamber; and a nut with an internal thread. A tunnel extends through the frame and across the accommodation chamber and is configured to receive a fastener extending through the tunnel. The frame includes, at an end of the tunnel, a sleeve having an external thread and extending through an opening in the cover plate to an outer side of the cover plate. The cover plate abuts a shoulder of the sleeve. The nut is screwed onto the external thread of the sleeve such that an axial end face of the nut abuts the outer side of the cover plate. The nut includes a thread seal at the internal thread sealing the nut to the sleeve and an axial seal at the axial end face of the nut, extending around the sleeve, and sealing the nut to the outer side of the cover plate.

The thread seal may include a sealing coating.

The internal thread of the nut may be a fine thread.

The axial seal may include a sprayed-on gasket.

The axial seal may include a thermoplastic elastomer (TPE).

The axial seal may include a rubber sealing that is vulcanized into a groove of the nut.

The axial seal may be arranged at a radial distance from the internal thread of the nut such that it does not extend into a gap between the cover plate and the sleeve.

The nut may further include an upper seal for sealing an upper end of the nut to the sleeve.

The upper seal may include an inner circular lip abutting an outer surface of the sleeve.

The cover plate may be a top cover plate or a bottom cover plate.

Another embodiment of the present disclosure provides an electric vehicle including the battery system as described above.

The electric vehicle may further include a carrying structure and the fastener extending through the tunnel of the frame of the battery system to fasten the battery system to the carrying structure.

Further aspects, features, and embodiments of the present disclosure can be learned from the following description.

### BRIEF DESCRIPTION OF THE DRAWINGS

Aspects and features of the present disclosure will become apparent to those of ordinary skill in the art by describing, in detail, embodiments thereof with reference to the attached schematic drawings, in which:

FIG. 1 is a perspective view of a battery system according to an embodiment of the present disclosure.

FIG. 2 is an enlarged view of the area II in FIG. 1.

FIG. 3 is a cross-sectional view of a part of the battery system shown in FIG. 1.

FIG. 4 is a high-angle perspective view of a nut of the battery system shown in FIG. 1.

FIG. 5A is a low-angle perspective view of the nut of the battery system shown in FIG. 1.

FIG. 5B is a sectional view of the nut of the battery system shown in FIG. 1.

FIG. 6 is a perspective view of the battery system shown in FIG. 1 without a cover plate.

FIG. 7 is a perspective view of the battery system shown in FIG. 6 without battery cells.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to an embodiment of the present disclosure, a battery includes a battery housing including a frame and at least one cover plate. The cover plate may be a top cover plate and/or a bottom cover plate. For example, two cover plates may be provided—one top cover plate and one bottom cover plate. The cover plate (e.g., the bottom cover plate) may be disposed on or below the frame. Inside the battery housing and, thus, inside an inner space defined by the frame and the cover plate(s), an accommodation chamber is defined (or is formed) to accommodate a plurality of battery cells. Thus, the battery system includes a plurality of battery cells, for example, prismatic, pouch, or cylindrical battery cells. The battery cells may be arranged to form one or more battery packs.

The frame of the battery system forms part of a carrier framework of the battery system. The cover plate may also form part of this carrier framework. The carrier framework carries or supports the battery cells and provides a structural connection to the carrying structure of the vehicle in which the battery system is mounted/installed. For example, the frame may be an integral structure of the battery housing, which provides structural rigidity to the battery housing. The frame may include beams extending in a horizontal and/or vertical plane as rigidly joined supports to support the cover plate of the battery housing.

A tunnel, or passage, extends through the frame and through (or across) the accommodation chamber inside the frame. The tunnel extends from a first (e.g., lower) end of the accommodation chamber to a second (e.g., upper) end of the accommodation chamber. In other words, the tunnel has a first opening at a first end surface of the frame, extends from the first opening through the frame (and through the accommodation chamber) to a second opening at a second end surface of the frame. The tunnel has a circumferential wall that delimits the tunnel from the accommodation chamber. The tunnel thereby forms a sealed passage. In other words, the frame includes a beam extending through the accommodation chamber and connecting a first side of the frame with a second side of the frame, and the tunnel is formed inside the beam. The tunnel is configured to receive a fastening element (e.g., a fastener) to fasten the battery system to a carrying structure of a vehicle. That is, the tunnel is formed such that it may accommodate a fastener, for example, a screw or bolt, extending through the tunnel. For example, a cross-section or diameter of the tunnel may correspond to a cross-section or diameter of the fastener. The fastener may fasten the frame and, thus, the battery system, to a carrying structure of the vehicle.

The frame further includes, at an end of the tunnel, a sleeve extending at least in part through an opening in the cover plate to an outer side of the cover plate. The tunnel extends through the sleeve as well. In other words, the beam of the frame through which the tunnel is formed may extend above the cover plate. The section of the beam abutting the cover plate and extending through and above the cover plate is herein denoted as the sleeve. That is, the cover plate abuts a shoulder of the sleeve. The sleeve has a shoulder at where it contacts the cover plate. When the cover plate is a top cover plate, the cover plate may rest upon the shoulder of the sleeve. The shoulder is disposed at an inner side of the cover plate or at a first side of the opening of the cover plate, and the sleeve extends through the opening in the cover plate to the outer side of the cover plate or to a second side of the opening in the cover plate. The sleeve may be formed as a recess in the beam of the frame or the shoulder as a protrusion in the sleeve. The sleeve includes an external thread. That is, the outer surface of the sleeve has a thread formed therein.

The battery system further includes a nut having an internal thread. That is, the inner surface of the nut has a thread formed therein. The nut includes a thread seal and an axial seal. The thread seal is provided at the internal thread and may cover the internal thread of the nut, for example, in the form of a coating. The axial seal is “axial” in the sense that it is disposed at the axial end face of the nut, for example, at the axial end face abutting the cover plate. The axial seal encircles, extends around, or surrounds an outer surface of the sleeve in an assembled state of the battery system. In other words, the axial seal encircles, extends around, or surrounds a through-hole extending through the nut and including the internal thread. The axial seal may include two circular sealing lips which, in the mounted position of the nut, abut the outer surface of the cover plate. In an assembled state, the nut is screwed onto the sleeve such the internal thread of the nut and the external thread of the sleeve interact. The nut is screwed onto the sleeve such that an axial end face of the nut, that is, the end face including the axial seal, abuts the outer side of the cover plate. The nut may be screwed onto the sleeve such that the nut presses the cover plate onto the shoulder of the sleeve, thereby fastening or clamping the cover plate to the frame. Thereby, the axial seal encircling the sleeve seals the nut to the outer side of the cover plate. Further, the thread seal seals the nut to the sleeve.

The thread seal prevents water or other contaminants from entering between, or seeping in-between, the outer surface of the sleeve and the inner surface of the nut, thereby preventing water or other contaminants from entering the battery housing and the accommodation chamber. The axial seal prevents water or other contaminants from entering between, or seeping in-between, the axial end face of the nut and the outer side of the cover plate, thereby preventing water or other contaminants from entering the battery housing and the accommodation chamber. Thus, the battery system according to embodiment of the present disclosure includes a nut that provides dual-sealing: a first sealing via the thread seal that prevents water or other contaminants from entering the accommodation chamber via the threads; and a second sealing via the axial seal that prevents water or other contaminants from entering the accommodation chamber via the cover plate. Thus, the battery system may be fastened to the carrying structure of a vehicle via a fastener extending through the tunnel while providing protection for the battery cells. That is, the battery system according to embodiments of the present disclosure, prevents water or other external or environmental influences from entering the battery pack and causing safety issues via the nut and the sleeve. Thus, the battery system according to embodiments of the present disclosure allows for sufficient stability of the battery system due to the tunnel configured to receive the fastener while protecting the battery cells inside the battery system from external or environmental influences via the nut and sleeve by dual-sealing.

According to an embodiment, the thread seal includes a sealing coating. In other words, the thread seal may be applied to the internal thread of the nut via coating. The coating may be on a polyamide basis. Such a pre-coated thread may provide a simple and efficient sealing.

According to an embodiment, the internal thread of the nut is a fine thread. A fine thread is a thread having a smaller pitch than a regular thread. The thread pitches may be defined based on a suitable standard or norm, for example, an ISO standard, such as ISO 261 defining metric threads. For example, M10-1.50 may denote a regular thread while M10-1.25 may denote a fine thread, wherein 1.5 and 1.25 denote the pitch. The nut having a fine thread allows for the nut to be designed sufficiently flat such as to fulfill installation space requirements. That is, the nut having a fine thread requires less installation space. Due to the thread seal, a sufficient sealing may be achieved with a fine thread.

According to an embodiment, the axial seal includes a sprayed-on gasket. In other words, the axial seal may be formed via a spray-on coating or may be sprayed-on. Spraying on the axial seal may be a simple way of providing the axial seal.

According to an embodiment, the axial seal includes a thermoplastic elastomer (TPE). This may provide for a simple and efficient sealing.

According to an embodiment, the axial seal includes a rubber sealing that is vulcanized into a groove of the nut. That is, the nut may include a groove formed in the axial end face, and the axial seal is disposed inside and extends out from the groove. In other words, the axial seal may be a vulcanized seal or a gasket made of vulcanized rubber. For example, the polymers subjected to vulcanization may be polyisoprene (natural rubber) and/or styrene-butadiene rubber (SBR). Providing the axial seal as a rubber seal may provide for a simple and efficient sealing.

According to an embodiment, the axial seal is arranged at a radial distance from the internal thread of the nut such that it does not extend into a gap between the cover plate and the sleeve. Thus, in the assembled state, the axial seal is arranged at a radial distance from the sleeve. The gap refers to the cover plate, while abutting the shoulder of the sleeve, not extending onto an outer surface of the sleeve portion extending through the opening of the cover plate. In other words, the gap may be formed between the outer surface of the sleeve portion extending through the opening of the cover plate and the inner surface of the opening of the cover plate. Again, in other words, the opening in the cover plate may have a larger diameter or cross-section than the diameter or cross-section of the sleeve portion extending through the opening of the cover plate. The gap may denote the difference in diameter or cross-section. The gap between the cover plate and the sleeve may be present because of or to account for production tolerances of the cover plate and the frame. When the axial seal is arranged at a radial distance from the internal thread of the nut such that it does not extend into a gap between the cover plate and the sleeve, the axial seal does not extend into the gap but is rather arranged radially outwardly from the gap. That is, the axial sealing may be disposed farther radially outwardly than the gap to provide a continuous sealing surface on the cover plate. For example, the axial seal may be distanced so far from the internal thread of the nut that an inner end or circumference of the axial seal is disposed radially outwardly from the gap to ensure sufficient contact of the axial seal with the outer side of the cover plate and, thus, to provide reliable sealing.

Thus, in an embodiment, the nut may include an axial seal at the axial end face, encircling the sleeve, and sealing the nut to the outer side of the cover plate. The axial seal may be, for example, formed as a sprayed-on gasket or a rubber sealing that is vulcanized into a groove at the axial end face of the nut.

According to an embodiment, the nut further includes an upper seal for sealing an upper end of the nut to the sleeve. The upper seal may include an inner circular lip abutting an outer surface of the sleeve to further improve the sealing between the nut and the sleeve.

According to an embodiment, the cover plate is any one of a top cover plate and a bottom cover plate. As described above, the cover plate may be either a top cover plate or a bottom cover plate. Also, the battery housing may include both a top cover plate and a bottom cover plate. The embodiments of the cover plate described herein may apply to both a top cover plate and a bottom cover plate, if both are present.

Embodiments of the present disclosure also provide an electric vehicle including the battery system as described above.

According to an embodiment, the electric vehicle includes a carrying structure and the fastener. The fastener extends through the tunnel of the frame of the battery system to fasten the battery system to the carrying structure. The fastener thereby also extends through the through-hole in the sleeve. The battery system may, thus, be securely fastened to the carrying structure while maintaining a secure seal protecting the battery cells from water or other contaminants.

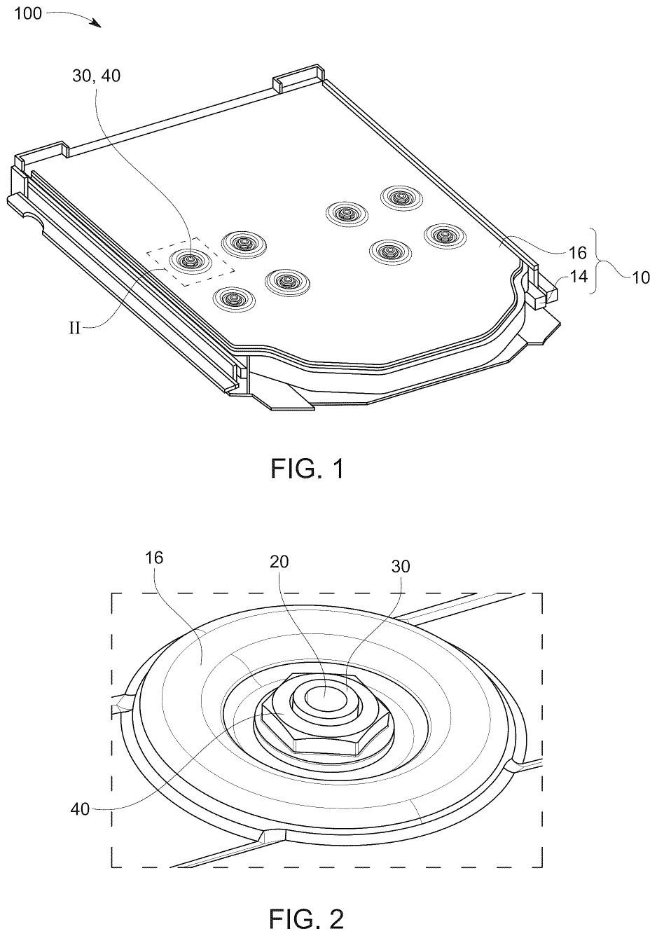

FIGS. 1 to 3 illustrate a battery system 100 according to an embodiment of the present disclosure. The battery system 100, which is shaped to fit into an underbody of an electric vehicle, includes a battery housing 10 enclosing (or forming) an accommodation chamber 11 inside of which a plurality of battery cells 12 are arranged. The battery housing 10 includes a frame 14 and a cover plate 16 disposed on or below the frame 14. The cover plate 16 may be a top cover plate or a bottom cover plate. The frame 14 forms part of a carrier framework of the battery system 100 via which the battery system 100 may be fastened to a carrying structure of an electric vehicle.

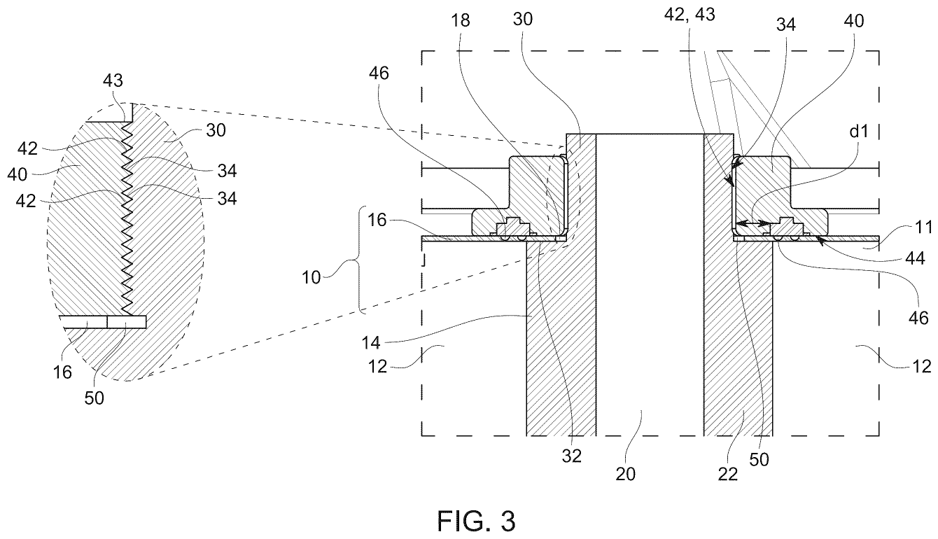

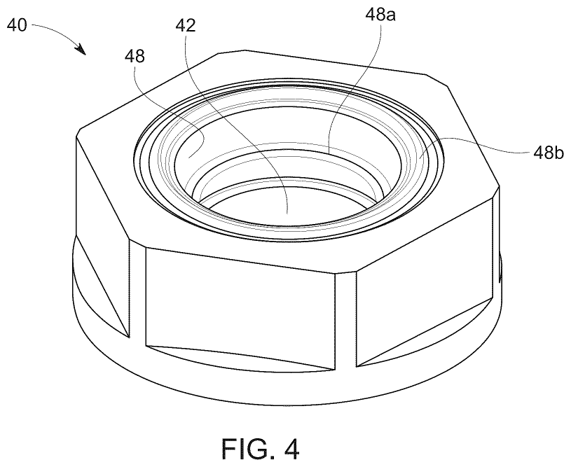

The frame 14 includes a tunnel (or opening) 20 extending through the frame 14 from an upper end of the battery system 100 to a lower end of the battery system 100 (see, e.g., FIG. 3, which shows part of the battery system 100 in a cross-sectional view). The tunnel 20 may be formed in a (cross)beam 60, which separates neighboring (or adjacent) battery cells 12. The tunnel 20 extends completely through the battery system 100 and, thus, also entirely through the accommodation chamber 11, that is, from a first end to a second end of the accommodation chamber 11. The tunnel 20 is delimited from the accommodation chamber 11 via a circumferential wall 22 of the frame 14. The tunnel 20 is configured to receive a fastener, which may extend through the tunnel 20 to fasten the battery system 100 to the carrying structure of the electric vehicle.

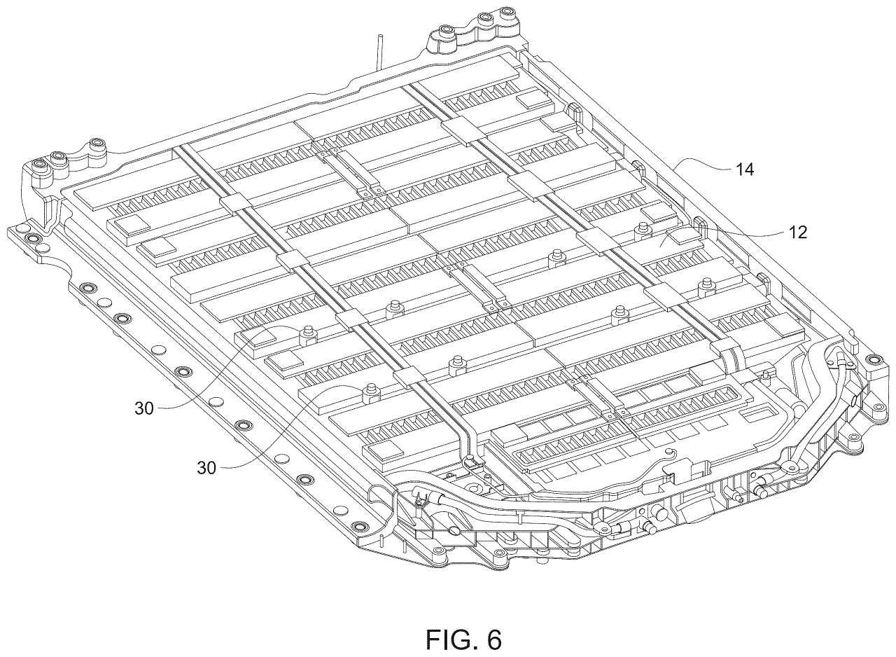

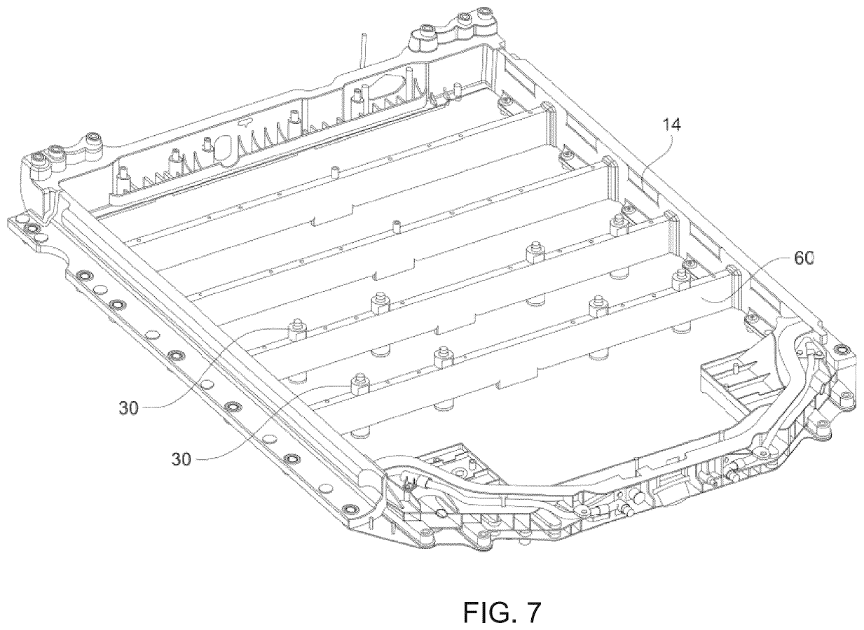

FIG. 6 shows the battery system 100 shown in FIG. 1 but with the cover plate 16 removed so that the view onto the underlying battery packs or battery cells 12 is unobstructed. FIG. 7 shows the battery system 100 shown in FIG. 6 but with the battery packs or battery cells 12 removed as well so that the frame 14 is visible. As can be seen in FIGS. 6 and 7, sleeves 30 are respectively arranged at ends of the crossbeams 60.

The frame 14 includes, at an end of the tunnel 20, a sleeve 30 extending through an opening 18 in the cover plate 16 to an outer side of the cover plate 16. The sleeve 30 includes a shoulder 32, which the cover plate 16 abuts, and an external thread 34 at the portion of the sleeve 30 extending above the opening 18. For example, a portion of the beam that includes the tunnel 20 extends through the opening 18 and above the cover plate 16, and the external thread 34 is formed at an outer surface of that portion of the beam, for example, on the sleeve 30.

The battery system 100 further includes a nut 40 having an internal thread (e.g., an internal fine thread) 42. The nut 40 is screwed onto the external thread 34 of the sleeve 30. The nut 40 is screwed onto the sleeve 30 such that an axial end face 44 of the nut 40 abuts an outer side of the cover plate 16 (see, e.g., FIGS. 2 and 3). Thus, the cover plate 16 is clamped between the shoulder 32 of the sleeve 30 and the axial end face 44 of the nut 40. The internal thread 42 of the nut 40 includes a coated sealing forming a thread seal 43 and sealing the nut 40 to the sleeve 30. Further, the nut 40 includes an axial seal 46 at the axial end face 44, with the axial seal 46 encircling (e.g., surrounding) the sleeve 30 and sealing the nut 40 to the outer side of the cover plate 16. The axial seal 46 may be, for example, formed as a sprayed-on gasket or a rubber sealing that is vulcanized into a groove at the axial end face 44 of the nut 40.

The nut 40 of the battery system 100 provides dual-sealing function including a first sealing via the thread seal 43, which prevents water or other contaminants from entering the accommodation chamber 11 via the threads 34, 42 and a second sealing via the axial seal 46 that prevents water or other contaminants from entering the accommodation chamber 11 via a passage between the cover plate 16 and the axial end face 44 of the nut 40. Thus, the battery system 100 may be fastened to the carrying structure of a vehicle via a fastener extending through the tunnel 20 while providing protection for the battery cells 12. That is, the battery system 100 according to embodiments of the present disclosure, prevents water and other external or environmental influences from entering the battery system 100 and causing safety issues via the nut 40 and the sleeve 30.

The axial seal 46 is arranged at a radial distance d₁ from the internal thread 42 of the nut 40 such that a gap 50 is formed (e.g., such that the nut 40 does not extend into the gap 50) between the cover plate 16 and the sleeve 30. The gap 50 may be a circumferential gap formed because the opening 18 in the cover plate 16 may have a larger diameter than the diameter of the sleeve 30 extending through the opening 18 in the cover plate 16. The gap 50 may be formed by or may account for production tolerances of the cover plate 16 and the frame 14. The axial sealing 46 is disposed farther radially outwardly than the gap 50, and the radial distance d₁ may be set (or designed) sufficiently large that an inner end or circumference of the axial seal 46 is disposed radially outwardly from the gap 50. This may ensure sufficient contact of the axial seal 46 with the outer side of the cover plate 16 and may provide for reliable sealing.

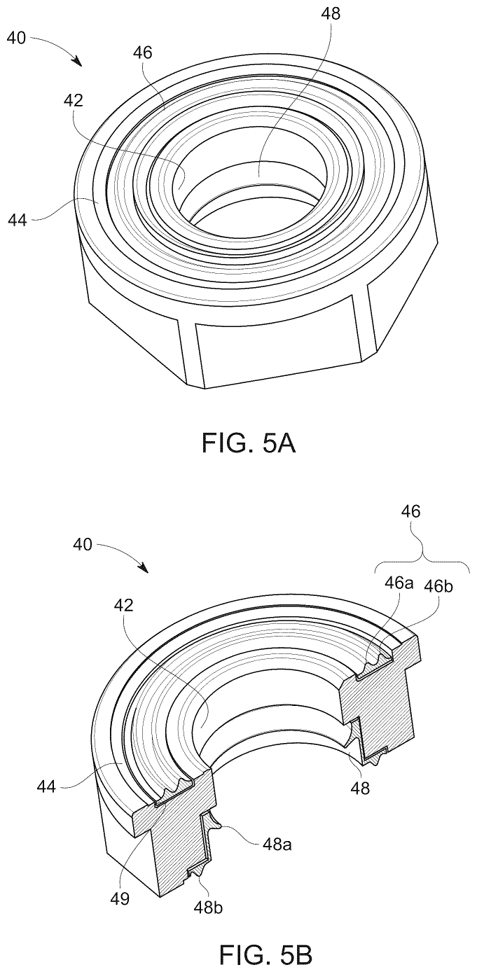

FIGS. 4, 5A, and 5B show an embodiment of the nut 40. In FIG. 4, the nut 40 is shown in a perspective view from above showing the internal thread 42, which interacts with the external thread 34 of the sleeve 30 (see, e.g., FIG. 3) to provide the above-described sealing. Further, the nut 40 may include an upper sealing structure 48 including an inner circular lip 48a and a top circular lip 48b. The inner circular lip 48a abuts an outer surface of the sleeve 30 when the sleeve 30 extends through the opening in the nut 40 and thereby provides further sealing. The top circular lip 48b may provide a sealing to a component arranged above the nut 40.

In FIGS. 5A and 5B, the nut 40 is shown in a perspective view from below and in a sectional view, respectively. In FIGS. 5A and 5B, the axial seal 46 can be seen in more detail. The axial seal 46, as described above, may be formed as a sprayed-on gasket or a rubber sealing that is vulcanized into a groove 49 in the axial end face 44 of the nut 40. The axial seal 46 may include two circular sealing lips 46a, 46b, which abut the outer surface of the cover plate 16 when the nut 40 is in the mounted position.

### DESCRIPTION OF SOME REFERENCE SYMBOLS

10 battery housing
11 accommodation chamber
12 battery cells
14 frame
16 cover plate
18 opening in cover plate
20 tunnel
22 circumferential wall of tunnel
30 sleeve
32 shoulder of sleeve
34 external thread
40 nut
42 internal thread
43 thread sealing
44 axial end face
46 axial sealing
46a circular sealing lip
46b circular sealing lip
48 upper sealing
48a inner circular lip
48b top circular lip
49 groove
50 gap
60 crossbeams
100 battery system

What is claimed is:

1. A battery system comprising:
a battery housing comprising a frame and a cover plate on the frame to define an accommodation chamber;
a plurality of battery cells accommodated in the accommodation chamber; and
a nut having an internal thread,
wherein a tunnel extends through the frame across the accommodation chamber such that a circumferential wall of the tunnel delimits the tunnel from the accommodation chamber, the tunnel is configured to receive a fastener extending through the tunnel to fasten the battery system to a carrying structure of a vehicle,
wherein the frame comprises, at an end of the tunnel, a sleeve extending through an opening in the cover plate to an outer side of the cover plate, the sleeve comprising an external thread,
wherein the cover plate abuts a shoulder of the sleeve, and
wherein the nut is screwed onto the external thread of the sleeve such that an axial end face of the nut abuts the outer side of the cover plate, the nut further comprising a thread seal at the internal thread sealing the nut to the sleeve and an axial seal at the axial end face of the nut, the axial seal extending around the sleeve and sealing the nut to the outer side of the cover plate.

2. The battery system as claimed in claim 1, wherein the thread seal comprises a sealing coating.

3. The battery system as claimed in claim 1, wherein the internal thread of the nut is a fine thread.

4. The battery system as claimed in claim 1, wherein the axial seal comprises a sprayed-on gasket.

5. The battery system as claimed in claim 1, wherein the axial seal comprises a thermoplastic elastomer.

6. The battery system as claimed in claim 1, wherein the axial seal comprises a rubber sealing that is vulcanized into a groove of the nut.

7. The battery system as claimed in claim 1, wherein the axial seal is arranged at a radial distance from the internal thread of the nut.

8. The battery system as claimed in claim 1, wherein the nut further comprises an upper seal for sealing an upper end of the nut to the sleeve.

9. The battery system as claimed in claim 8, wherein the upper seal comprises an inner circular lip abutting an outer surface of the sleeve.

10. The battery system as claimed in claim 1, wherein the cover plate is a top cover plate or a bottom cover plate.

11. An electric vehicle comprising the battery system as claimed in claim 1.

12. The electric vehicle as claimed in claim 11, further comprising a carrying structure; and
the fastener extending through the tunnel of the frame of the battery system to fasten the battery system to the carrying structure.
